(19) United States
(12) Patent Application Publication
(10) Pub. No.: US 2002/0175940 A1
(43) Pub. Date: Nov. 28, 2002

(54) Data cylinder for managing ad-hoc data sets

(76) Inventors: David B. Lection, Raleigh, NC (US); Marcia L. Peters, Durham, NC (US)

Correspondence Address: Esther H. Chong, Esquire, Synnestvedt & Lechner LLP, 2600 Aramark Tower, 1101 Market Street, Philadelphia, PA, 19107-2950, US

(21) Appl. No.: 09/862,271

(22) Filed: May 22, 2001

(51) Int. Cl. G09G 5/00

(52) U.S. Cl. 345/764

(57) ABSTRACT

A data cylinder functioning as a graphical user interface for managing ad-hoc data is disclosed. The data cylinder stores therein a plurality of related data sets representing ad-hoc data, and displays one of these data sets at a time. The data cylinder is laterally rotatable to display a different one of the related data sets. A new set of related data can be easily created based on existing data sets. By selecting the data set of the data cylinder displayed to the user, current data fields are automatically filled with the values in the selected data set.

### BACKGROUND OF THE INVENTION

1. Field of the Invention

The present invention relates to data management systems and, more particularly, to a unique data cylinder functioning as a graphical user interface (GUI) for managing sets of ad-hoc data and a method of managing the ad-hoc data sets using the data cylinder.

2. Discussion of the Related Art

Different online merchants require different information from users on their web forms such as online order forms, online registration forms, etc. For instance, one merchant may require the name, mailing address, and the e-mail address of the user on their registration form, whereas another merchant may require the name, social security, e-mail address, and the telephone number of the user on their registration form. Sets of data (values) entered by the user into the data fields of different web forms are considered “ad-hoc” data because they have arbitrary forms, sizes, and/or structures.

Conventional web browsers such as Internet Explorer by Microsoft, Inc. are capable of collecting such ad-hoc data sets and managing them to provide an “auto-complete” feature. According to this auto-complete feature, values entered by a user to fill certain data fields of a web form are stored in the user's computer. Then, when the user is ready to fill out a new web form and begins typing a value for a particular data field on the web form, the auto-complete feature provides a dropdown list on the user's computer screen. This drop-down list identifies a plurality of different data values that have been previously entered by the user for the data field having the same field name (e.g., “name”) as the current data field and that best match the user's input for the field. The user selects one value from the drop-down list, which triggers the user's computer to fill in automatically the current data field with the selected value.

A number of problems, however, exist with such conventional ad-hoc data management systems. First, the conventional system provides a drop-down list for one data field at a time. To complete multiple data fields typically present in one web form, for each data field, the user must begin entering a value for the field, view the drop-down list associated with the field and select a value from the drop-list for the field. This process can be time consuming to the user, thereby reducing the effect and usefulness of the auto-complete feature significantly.

Furthermore, the conventional system does not recognize relationships between data fields so that the data values can be used out of context. For instance, an online order form may request a home address comprised of four related data fields, namely, street name, city, state and zip code. Although these data fields are related, the conventional system stores values for each of these fields individually and does not store relational information on these fields. Thus, the conventional drop-down list often includes certain items that are completely irrelevant for the particular data field. Moreover, since the conventional system is unable to recognize related data fields, a large number of items are often displayed in the drop-down list. As the number of items displayed in the drop-down list increases, it becomes more difficult for the user to view the list and select the appropriate value from the list, quickly. In addition, a large number of items in the drop-down list clutters the screen view and often makes it extremely difficult for the user to find the appropriate value from the list.

There exist other types of systems for managing data sets. For instance, spreadsheets such as Lotus 123, Microsoft Excel, etc. manage data sets using a matrix. In spreadsheets, data sets are organized in a matrix composed of columns and rows. Spreadsheets allow the sorting of data by one or more columns arranged in a certain priority order. However, such systems are not suitable for managing ad-hoc data sets because the arbitrary formats and sizes of the ad-hoc data sets make it often difficult to convert them into a matrix format.

Accordingly, a need exists for a technique or tool for managing ad-hoc data sets which overcomes the above described problems and other problems encountered in conventional ad-hoc data management systems and methods.

### SUMMARY OF THE INVENTION

The present invention provides a unique graphical user interface (GUI) that includes a “data cylinder” for managing ad-hoc data sets which overcomes problems associated with conventional ad-hoc data management systems and methods. Particularly, the “data cylinder” of the present invention is a computer-generated graphical image of an object having a cylindrical or cylinder-like configuration. The data cylinder has a single viewing facet for displaying to a user a set of related data at a time. The data cylinder, which is visually displayed on the user's computer screen, is comprised of a plurality of subcylinders, wherein each subcylinder is associated with storing multiple values for a particular data field. As an example, a set of personal data applicable to filling out web forms at home may be considered one set of related data, whereas a set of personal data applicable to filling out web forms at work may be considered a different set of related data. The data cylinder, i.e., the graphical representation, is laterally rotatable to display a different one of the related data sets. A new set of related data can be easily created based on existing data sets.

By selecting a data set of the data cylinder displayed to the user, data fields of a new web form can be filled automatically with the values in the selected data set for those data fields having the same names as the field names associated with the selected data set. The user is also able to fill data fields of a new web form individually by selecting an appropriate value from the displayed data set, e.g., by selecting, dragging, and dropping the appropriate value from the data cylinder into a field that the user desires to fill.

The data cylinder of the present invention is advantageous over other graphical images or GUIs of prior art systems, such as drop-down lists, because it allows the user to view only one set of related data at a time, thereby hiding the complexity of manipulating multiple data sets. At the same time, it allows easily an unlimited number of related data sets to be stored, organized, sorted, and used.

### BRIEF DESCRIPTION OF THE DRAWINGS

FIG. 1 is a flow chart illustrating the processing steps of a method of managing ad-hoc data according to one embodiment of the present invention.

FIG. 2A is an example of a data cylinder according to one embodiment of the present invention.

FIG. 2B is an exploded view of the data cylinder of FIG. 2A according to one embodiment of the present invention.

FIG. 3 is an example of a data cylinder illustrating a simultaneous rotation of all subcylinders according to one embodiment of the present invention.

FIGS. 4A, 4B and 4C are examples of data cylinders for illustrating an editing process according to one embodiment of the present invention.

FIGS. 5A, 5B and 5C are examples of data cylinders for illustrating a different editing process according to one embodiment of the present invention.

FIG. 6 is a block diagram of a computer system in which the present invention can be implemented according to one embodiment of the present invention.

### DETAILED DESCRIPTION OF THE PREFERRED EMBODIMENTS

In the drawings, the same reference numerals are used to indicate the same elements.

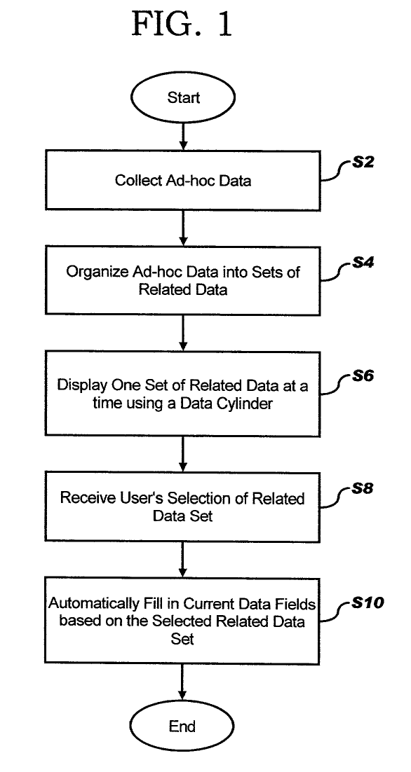

FIG. 1 is a flow chart illustrating the processing steps of a method for managing ad-hoc data according to one embodiment of the present invention. These precessing steps are implemented by a computer or processor and can be written in any known programming language such as Java, C++, Visual Basic, etc. In one implementation, these processing steps are executed by a user's personal computer (PC) loaded with software programming necessary to execute these steps. This software programming can be stored in the user's PC as one of the application programs and can be configured to interact with a web-browser application program loaded in the user's PC.

As shown in FIG. 1, in Step S2, the user's computer is configured to collect ad-hoc data such as sets of values that the user has entered to his or her computer in filling out data fields such as the data fields of a web form. This can be accomplished by configuring the user's computer to store values (data) entered in association with data fields.

In Step S4, the collected ad-hoc data are organized into sets of related data by the user's computer. For instance, the user's computer can be configured to designate all the values entered to fill out one web form as one set of related data, and all values entered to fill out another web form as another set of related data. Then in Step S6, the sets of related data stored in the user's computer are displayed to the user, only one set at a time, using a graphical user interface (GUI) referred to herein as a “data cylinder”. The data cylinder is a computer-generated graphical image having a cylindrical or cylinder-like configuration, which will be described below in more detail. The displaying step S6 can occur in response to the user's request, or automatically when the user currently needs to fill in certain data fields. The determination as to which set should be displayed first to the user in Step S6 can be made according to certain criteria. For example, the set of related data that matches the data fields to be filled currently (e.g., having the same field names) can be shown, or the set of related data that is most frequently or recently used by the user can be shown first.

The user views the set of related data displayed by the data cylinder. If the user desires a different set of related data, the data cylinder can be rotated or scrolled laterally to display a different set of related data. Once it is determined that the displayed set of related data is acceptable for any one or more of the current data fields (e.g., data fields of a new web form), the user selects the displayed set of data. Here, the user can select the entire data set or each value in the data set individually. The user's selection is received by the user's computer in Step S8. The user's selection can be made by any known techniques, such as, using designated keys, double clicking on the entire data cylinder or an individual value displayed in the cylinder, dragging and dropping the entire data cylinder or an individual value from the cylinder to the field(s) of a new web form, etc.

In Step S10, in response to the user's selection, the user's computer is configured to fill automatically one or more of the current data fields with the selected value(s). If the user has selected the entire data set, then the user's computer is configured to fill automatically the current data fields that have the same field names as the field names associated with the selected data set. If there is no value for a particular current data field in the selected set of related data, then that data field is left blank. If certain data fields are not found in the selected set of related data, then those data fields are also left blank. Blank or unfilled data fields can be filled manually by the user if appropriate. If the user has selected one value from the displayed data set for a particular current data field, then the user's computer is configured to fill that particular current data field with the selected value.

Accordingly, the user is able to fill data fields, conveniently, using the data cylinder. Further, the user sees only one set of related data at a time by the operation of the data cylinder. This is an advantageous because the present invention hides the complexity of using numerous data sets from the user and provides a simple cylinder for easily allowing the use of an unlimited number of different sets of related data.

One skilled in the art would readily understand that the various steps discussed above can be repeated continuously and/or simultaneously and that the order of the steps can vary depending on the application. For instance, values manually entered by the user to fill certain fields that could not be filled by using the data cylinder in Step S10 are collected and stored appropriately into the data cylinder (Step S2).

In accordance with one implementation of the processing steps discussed above in connection with FIG. 1, when the user types in values for certain data fields in a web form, these values automatically fill (e.g., via the interaction with the web-browser) an empty data cylinder which is not visible to the user. This can occur at the initial setup of the cylinder, and the fields of the data cylinder can be designated to correspond to the fields associated with the values entered by the user. The user also adds new data sets manually into the data cylinder. Then, when the user tries to fill a new web form, the data cylinder appears on the user's computer screen (as a graphical image) which displays a certain set of related data according to predetermined criteria. The user can rotate, visually, the entire data cylinder, so that a different set of related data is displayed. The user can edit old data sets or create new data sets using the edit processes which will be discussed below. The new web form is filled using the data cylinder as discussed above.

According to one embodiment, the user's computer can be configured to automatically obtain the ad-hoc data such as the values entered to fill web forms. This can be accomplished by providing a plug-in (exploiter program) capable of interacting with the application programming interface (API) of the user's web-browser application program. For example, conventional web-browsers include an API known as a “Plug-in API” which allows a third-party plug-in to interact with the web-browser. By providing a plug-in for interacting with the web browser's API, all values (data) entered by the user to fill data fields and values (e.g., data field names) provided by external sources such as online vendors can be viewed and stored by the programming of the present invention. Then these values associated with the data fields will be organized by the user's computer into sets of related data according to predetermined or user-defined criteria. According to another embodiment, the ad-hoc data may be obtained by requesting the user to input directly into an empty data cylinder. Obviously, there are a variety of different ways in which the ad-hoc data can be collected by the user's computer, and all such variations are contemplated as part of the present invention.

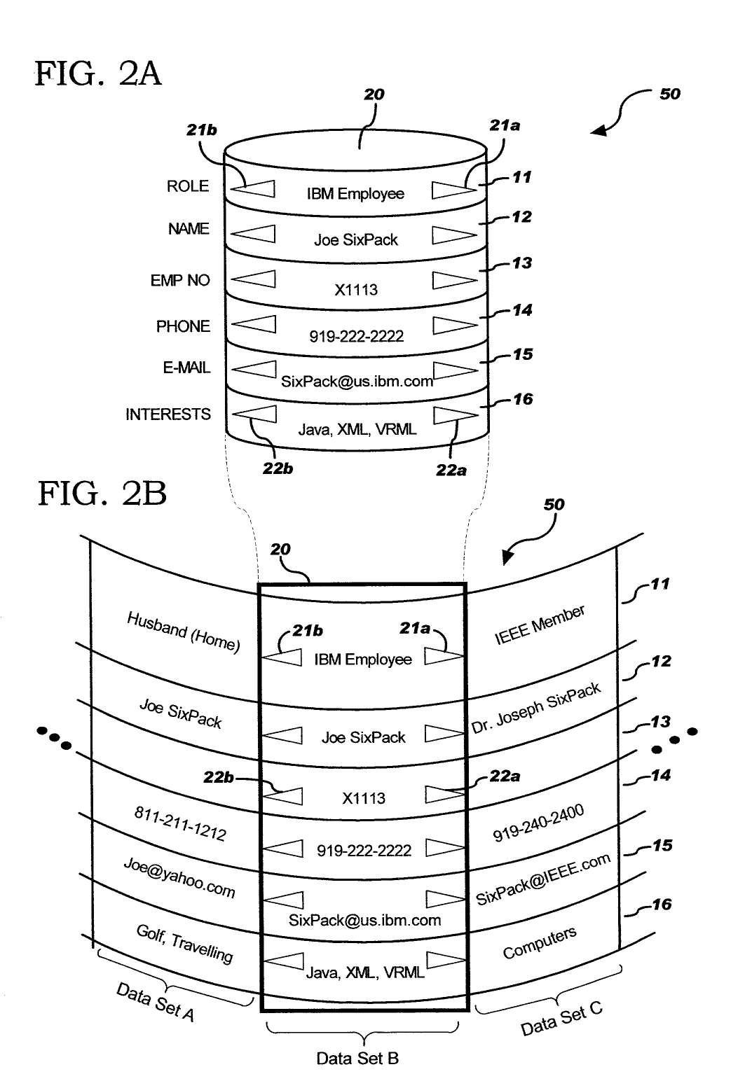

FIG. 2A is a diagram of a data cylinder 50 displayed to a user and FIG. 2B is an exploded view of the data cylinder 50 of FIG. 2A according to one embodiment of the present invention. The data cylinder 50 is a graphical user interface (GUI) displayed on the user's computer screen and is generated by executing a computer program. This GUI control programming can be written in any known computer programing language such as Java, C++, Visual Basic, etc. according to existing programming techniques. The data cylinder 50 is used in the processing steps discussed in connection with FIG. 1 according to one embodiment of the present invention.

As shown in FIGS. 2A and 2B, the data cylinder 50 is a computer generated graphical representation and has a cylindrical or cylinder-like configuration. It is comprised of a plurality of subcylinders 11, 12, 13, 14, 15, and 16. Each of the subcylinders 11-16 is assigned to a particular data field and stores multiple values (data) for that data field. The top subcylinder 11 is designated as a key subcylinder, and all other subcylinders 12-16 below the key subcylinder 11 are designated as subordinate subcylinders. The key subcylinder 11 functions as a sort key such that all values stored in the data cylinder 50 can be sorted and organized based on the key subcylinder 11. The data field for the key subcylinder 11 is referred to herein as a key field, and the data fields for the subordinate subcylinders 12-16 are referred to herein as subordinate fields.

The values stored in the data cylinder 50 are arranged into sets of related data. For instance, as shown in FIG. 2B, the data cylinder 50 stores a plurality of data sets, Data Sets A, B, C . . . . Each data set is comprised of values for the different data fields of the data cylinder 50. The values in one data set are grouped as one because they are related to each other. For instance, Data Set B has a collection of values “IBM Employee”, “Joe SixPack”, “X1333”, “919-222-2222”, “SixPack@us.ibm.com”, and “Java, XML, VRML” corresponding to the key and subordinate fields of the data cylinder 50. Basically, Data Set A represents a collection of values applicable when the user functions in the role of an IBM Employee (i.e., the value of the Role field is “IBM Employee”). These values indicate that, when the user functions as an IBM Employee, his name is Joe SixPack, his employee number is X113, his phone number is 919-222-2222, his email address is SixPack@us.ibm.com, and his interests are Java, XML, VRML. Data Set A represents a collection of values applicable when the user functions as a husband at home (i.e., the value of the Role field is “Husband (Home)”. Similarly, Data set C represents a collection of values when the user functions as an IEEE member. In this manner, the data cylinder 50 contains multiple sets of related data each distinguishable by the value of the key field, in this case, roles.

It is possible for certain data fields to be without values. For example, Data Set A does not have a value for the Employee Number field because this data field is not applicable when the user functions as a husband at home.

The data cylinder 50 is configured to display only one set of related data at a time through a viewing facet 20. In a preferred embodiment, the data cylinder 50 only has one viewing facet 20 capable of showing only one set of related data at a time. For instance, the user sees only what is shown in FIG. 2A and not the data sets outside the viewing facet 20 shown in FIG. 2B. To view other data sets hidden from the user, the data cylinder 50 provides means for scrolling through different sets of related data. As one example of such scrolling means, the key subcylinder 11 includes first and second scrolling arrows 21a and 21b, and each of the subordinate subcylinders 12-16 provides first and second scrolling arrows 22a and 22b. The scrolling arrows 21a and 21b will always be visible to the user in the viewing facet 20 regardless of which data set is displayed. One skilled in the art would also appreciate that any other types of scrolling means can be used in the present invention.

The scrolling arrows 21a and 21b of the key subcylinder 11 control the lateral rotation of the entire data cylinder 50. That is, the actuation of one of the scrolling arrows 21a and 21b causes a simultaneous lateral rotation of all subcylinders 11-16 in one direction. In comparison, the scrolling arrows 22a and 22b of each of the subordinate subcylinder 12-16 cause a lateral rotation of only the corresponding subordinate subcylinder. Thus, by the operation of the scrolling arrows 22a and 22b, each subordinate subcylinder can be individually rotated laterally. The user can click on each of these scrolling arrows to cause the rotation. The actuation of the first scrolling arrow 21a or 22a causes the corresponding subcylinder(s) to rotate in one direction (e.g., counter-clockwise or to the right). The actuation of the second arrow 21b or 22b causes the corresponding subcylinder(s) to rotate in the opposite direction (e.g., clockwise direction or to the left).

A click of a scrolling arrow causes the corresponding subcylinder(s) 11-16 to rotate to a predetermined amount so that the next adjacent value(s) appears. For example, if the user currently sees Data Set B as shown in FIG. 2B and clicks the first scrolling arrow 21a once, then Data Set C is displayed on the viewing facet 20. Thereafter, if the user clicks on the second scrolling arrow 21b twice, then Data Set A is displayed in the viewing facet 20. In this manner, the user can scroll through all the data sets stored in the data cylinder 50.

In one example as shown in FIG. 2A, the key cylinder 11 is visually distinguished from the subordinate subcylinders 12-16 with a greater cylinder thickness/height so that the user knows which subcylinder is currently functioning as the key cylinder. Of course, any other means can be used to distinguish the key subcylinder 11 from other subcylinders, such as using a different color, a different font, a blinking feature, etc. Further, the data cylinder 50 can appear automatically whenever the user currently needs to fill data fields (e.g., by the interaction with the web browser), or in response to the user's request, e.g., by the operation of certain screen icons using the computer input device such as a mouse, a keyboard, etc.

The user can also rearrange the subcylinders to designate the key subcylinder. For example, the user can drag one of the subordinate subcylinders 12-16 to the top of the data cylinder, causing the dragged subcylinder to function as a new key subcylinder. Once the new key subcylinder has been designated, all the values in the fields of the subordinate sub-cylinders are automatically rearranged or sorted so that they correspond to the values of the key subcylinder. Further, the user can rearrange the order of the subordinate subcylinders 12-16 in the data cylinder 50. Although FIG. 2A shows that the field names associated with the subcylinders are visible to the user, it is possible to hide these field names from the user. In lieu of these fields names, it is also possible to provide more user-friendly names that correspond to the actual field names associated with the subcylinders.

Moreover, although the scrolling arrows of the data cylinder are configured to rotate the subcylinder(s) laterally, it is possible to provide scrolling means that cause a vertical rotation of the cylinder. In this case, the cylinder would need to be rotated about 90 degrees, so that the cylinder is laid on the side. This would allow a vertical rotation of the subcylinder(s). This scheme may be applicable in countries where their texts are written vertically.

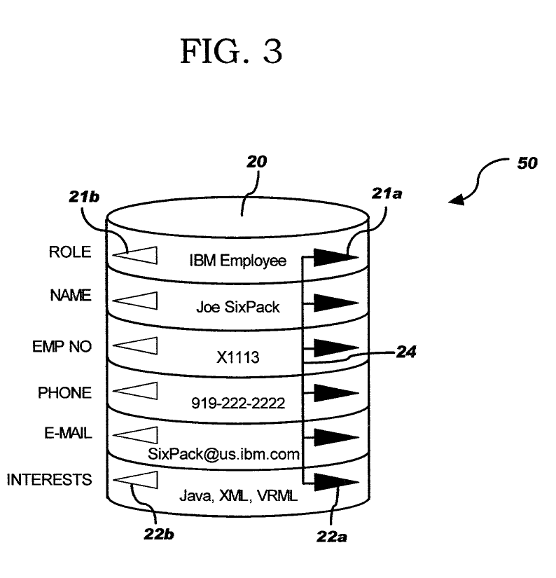

The actuation of the scrolling arrows 21a and 21b in the key subcylinder 11 which causes an automatic and simultaneous scrolling of all subordinate subcylinders 12-16, can be visually represented so that the user is aware of the operation of the data cylinder. For example, FIG. 3 shows the data cylinder 50 having connected arrows 24 for indicating that all the subcylinders are being scrolled together. The connected arrows 24 will be shown when the user selects one of the scrolling arrows 21a and 21b in the key subcylinder 11. One skilled in the art will readily understand that any other means can be used to indicate the simultaneous scrolling of all subcylinders 12-16.

Each value stored in the subcylinders 11-16 is editable by the user. This editing mechanism can be implemented as follows. The user enters an editing mode, e.g., by clicking a designated button. In this mode, each time the user changes a value in one of the subordinate subcylinders 12-16, the user's computer is configured to request an additional input from the user to determine whether the user intends to modify just that value in the currently displayed data set, or to create a new data set having the modified value. A pop-up message or some other means can be used to solicit this type of user input.

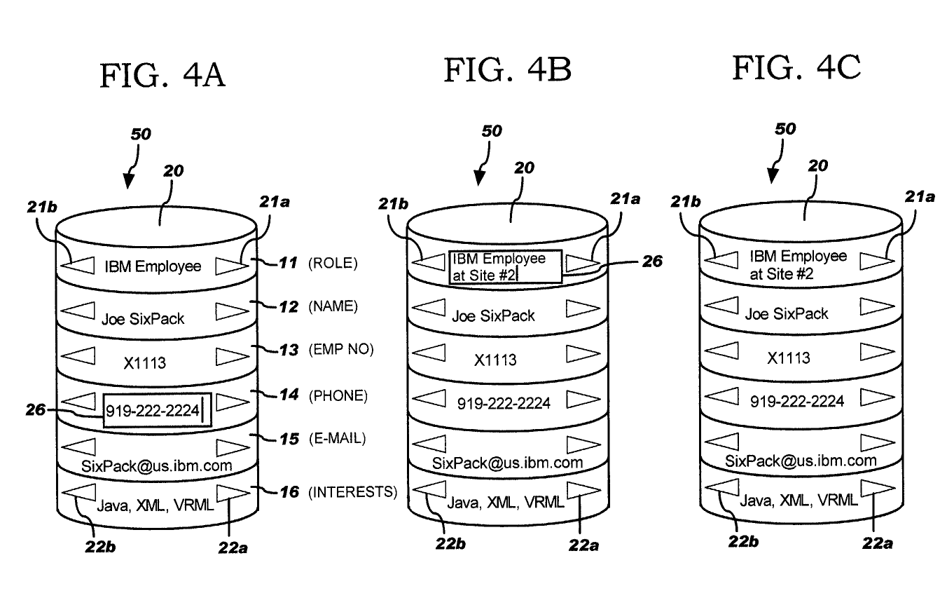

According to one example of an editing process of the present invention, the user selects the value of a particular subcylinder that the user wishes to edit. This creates an editing box around the value and the user can modify the value in the box. FIGS. 4A, 4B, and 4C show examples of the data cylinder 50 illustrating an editing process according to one embodiment of the present invention. As shown in FIG. 4A, if the user wishes to edit the phone number, the user selects the value of the “phone” subcylinder 14. This creates an editing box 26 around the value and the user can modify the value (phone number).

Once the user completes the editing process, e.g., by entering a “return” button or other designated key, the value change is implemented and the subcylinder 14 will indicate the new value of “919-222-2224” as shown in FIG. 4B. At this moment, the user's computer is configured to display automatically an editing box 26 around the value “IBM Employee” in the key subcylinder 11. Simultaneously, a pop-up message appears on the user's computer screen. This message solicits an additional input from the user to determine the user's intention behind initiating the editing process. For example, a message such as the following may appear on the user's screen:

You have modified the value for the “Name” field. Modify the “Role” field value if want to create a new data set based on the modified Name value, or press “X” button if you want to update the value for the Name field for the current data set.

If the user merely wishes to change the phone number for the current data set (e.g., because the user's phone number has changed), then the user presses the X button and the current data set is modified with the new phone number value for the subcylinder 14. All other values for the other subcylinders will not change.

However, if the user wishes to create an additional data set that has all the values of the current data set except for the telephone number (e.g., for working at a different job site), then the user modifies the Role value to designate a new data set, e.g., “IBM Employee at Site #2”. The user can press a return button or the like thereafter, which causes a new, additional data set to be created. Basically, the computer is configured make a copy of the current data set, change the value in the data set, and thereby create a new data set. Thus, the newly created data set will have the values as shown in FIG. 4C with the “IBM Employee at Site #2” as the Role value, and “919-222-2224” as the Phone value. The creation of the new data set does not affect the existence of the old data set based on which the new data set is created.

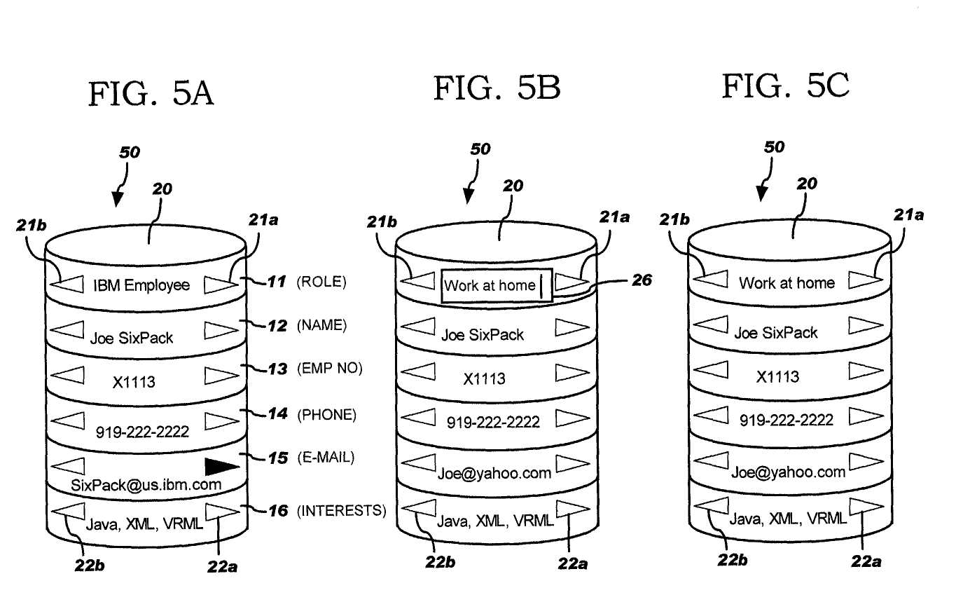

FIGS. 5A, 5B and 5C are examples of data cylinders 50 for illustrating a different editing process according to one embodiment of the present invention. This way of editing the values is similar to the way discussed in connection with FIGS. 4A-4C, except that the user utilizes the scrolling arrows to modify the values. As shown in FIG. 5A, when the user is in the editing mode, the user actuates one of the scrolling arrows 22a or 22b to rotate a corresponding subordinate cylinder. This causes an adjacent value to appear for that subcylinder. For example, if the user actuates the right scrolling arrow 22a for the E-mail field, then the subcylinder 15 rotates right or counterclockwise, and the value for the E-mail field in the adjacent left data set (Joe@yahoo.com as shown in FIG. 2B) appears as shown in FIG. 5B. Simultaneously, a pop-up message appears on the user's computer screen (as discussed above in connection with FIGS. 4A-4C) to determine whether a new data set is to be created or the current data set is to be merely updated with the new value. If the user intends to create an additional data set, then the user modifies the Role field value to a new value, e.g., “Work at home” and implements this change to create a new, additional set of related data as shown in FIG. 5C.

Although two exemplary editing procedures have been discussed above, any other editing mechanism can be used in the present invention as long as the user is able to selectively edit values in each subcylinder and/or create a new data set using the editing process. In the alternative, the user may create a new data set by pressing a designated “create” button. In this case, the user may need to enter each value to the corresponding subcylinder of the data cylinder.

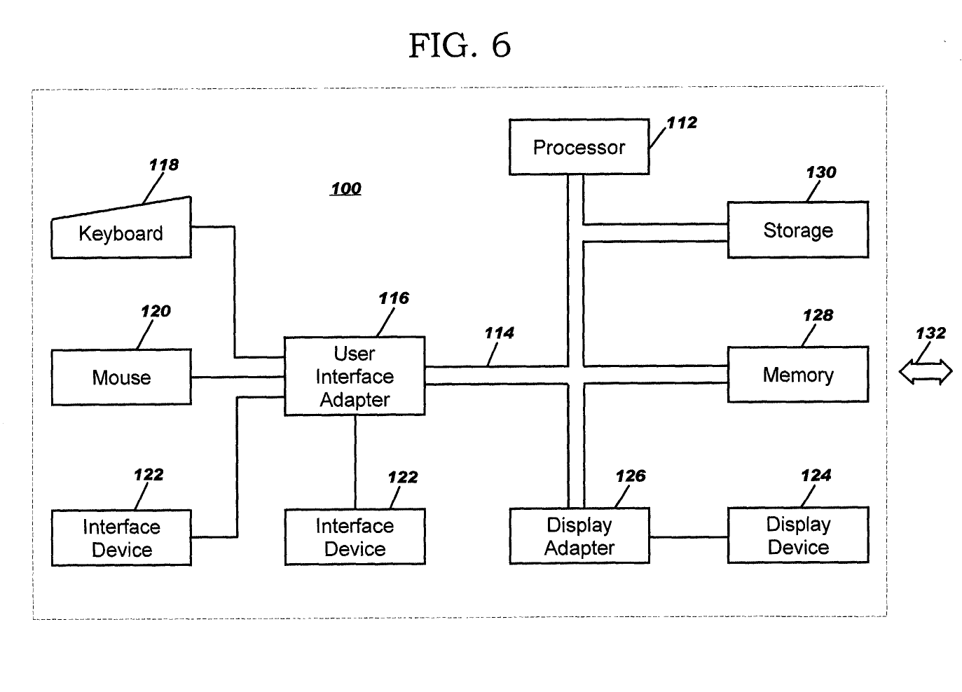

FIG. 6 illustrates a representative workstation hardware environment in which the present invention may be practiced. The environment of FIG. 6 comprises a representative single user computer workstation 100, such as a personal computer, a portable computer, a desktop, a laptop, including related peripheral devices. The workstation 100 includes a microprocessor 112 and a bus 114 employed to connect and enable communication between the microprocessor 112 and the components of the workstation 100 in accordance with known techniques. The workstation 100 typically includes a user interface adapter 116, which connects the microprocessor 112 via the bus 114 to one or more interface devices, such as keyboard 118, mouse 120, and/or other interface devices 122, which can be any user interface device, such as a touch sensitive screen, digitized entry pad, etc. The bus 114 also connects a display device 124, such as an LCD screen or monitor, to the microprocessor 112 via a display adapter 126. The bus 114 also connects the microprocessor 112 to memory 128 and long term storage 130 which can include a hard drive, tape drive, etc. The workstation 100 communicates via a communications channel 132 with other computers, networks of computers, or a communication network such as the Internet. The workstation 100 may be associated with such other computers in a local area network (LAN) or a wide area network, or the workstation 100 can be client in a client/server arrangement with another computer, etc. All of these configurations, as well as the appropriate communications hardware and software, are known in the art.

Software programming code which embodies the present invention is typically stored in permanent storage of some type, such as the permanent storage 130 of the workstation 100. Other programs such as operating systems, web-browser programs, and other application programs can also be stored in the storage 130. The software programming code of the present invention may be embodied on any of a variety of known media for use with a computer system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

Accordingly, the present invention is applicable to any system that supports event-driven graphical user interfaces. The applicability is not limited to managing ad-hoc data sets, but extends to any other sets of data. For instance, the present invention is equally applicable to organize, sort and manage sets of data having predetermined structures and formats using a data cylinder.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A graphical user interface (GUI) for managing data sets, wherein the GUI includes a cylindrical object which is associated with storing a plurality of related data sets and displays to a user one of the related data sets at a time, wherein the cylindrical object is a computer-generated graphical image having a cylindrical configuration.

2. The GUI of claim 1, wherein the cylindrical object is rotatable to display a different one of the related data sets.

3. The GUI of claim 1, wherein the related data sets include personal information of the user.

4. The GUI of claim 1, wherein the cylindrical object includes:
a key subcylinder, assigned to a key data field, for storing a plurality of values corresponding to the key data field; and
a plurality of subordinate subcylinders assigned respectively to a plurality of subordinate data fields, each of the subordinate subcylinders storing a plurality of values corresponding to the assigned subordinate data field.

5. The GUI of claim 4, wherein the cylindrical object further includes:
a viewing facet for displaying one of the related data sets to the user and hiding all other related data sets from the user, wherein the one of the related data sets that is displayed includes values corresponding to the key data field and the subordinate data fields.

6. The GUI of claim 5, further comprising:
a first scrolling unit for rotating simultaneously the key and subordinate subcylinders to a predetermined amount in a first direction to display a different one of the related data sets; and
a second scrolling unit for rotating simultaneously the key and subordinate subcylinders to the predetermined amount in a second direction to display a different one of the related data sets.

7. The GUI of claim 6, wherein the first and second directions are opposite directions.

8. The GUI of claim 5, further comprising:
a third scrolling unit disposed at each of the subordinate subcylinders for rotating the corresponding subordinate subcylinder in a first direction; and
a fourth scrolling unit disposed at each of the subordinate subcylinders for rotating the corresponding subordinate subcylinder in a second direction.

9. The GUI of claim 4, wherein all data stored in the cylindrical object are sorted based on the key subcylinder.

10. The GUI of claim 4, wherein the cylindrical object is selectively rearrangeable by designating one of the subordinate subcylinders as a new key subcylinder.

11. The GUI of claim 1, wherein the plurality of related data sets are ad-hoc data entered by the user when filling web forms.

12. A method of managing data sets using a cylindrical object functioning as a graphical user interface, the method comprising the steps of:
obtaining a plurality of related data sets corresponding to a plurality of data fields;
identifying one of the data fields as a key field;
organizing the plurality of related data sets based on the key field; and
displaying one of the related data sets at a time using the cylindrical object.

13. The method of claim 12, wherein, in the displaying step, the one of the related data sets is displayed in the cylindrical object in response to a user's request.

14. The method of claim 12, further comprising:
determining whether any data field needs to be filled currently by a user; and
displaying one of the related data set based on certain criteria when the determining step indicates that the data field needs to be filled.

15. The method of claim 12, further comprising:
receiving a user's selection of one of the related data sets that is displayed by the cylindrical object; and
automatically filling current data fields with the selected related data set.

16. The method of claim 12, further comprising:
rotating the cylindrical object in response to a user's request to display a different one of the related data sets.

17. The method of claim 12, wherein the related data sets include personal information of a user.

18. The method of claim 12, wherein the cylindrical object includes a key subcylinder, assigned to a key data field, for storing a plurality of values corresponding to the key data field; a plurality of subordinate subcylinders assigned respectively to a plurality of subordinate data fields, each of the subordinate subcylinders storing a plurality of values corresponding to the assigned subordinate data field; and a viewing facet for displaying one of the related data sets in the displaying step, wherein the displayed one of the related data sets includes values corresponding to the key data field and the subordinate data fields.

19. The method of claim 18, further comprising:
rotating simultaneously, using a first scrolling unit associated with the key subcylinder, the key and subordinate subcylinders to a predetermined amount in a first direction to display a different one of the related data sets; and
rotating simultaneously, using a second scrolling unit associated with the key subcylinder, the key and subordinate subcylinders to the predetermined amount in a second direction to display a different one of the related data sets.

20. The method of claim 18, further comprising:
rotating the subordinate subcylinders individually in a first direction using a third scrolling unit associated with each of the subordinate subcylinders; and
rotating the subordinate subcylinders individually in a second direction using a fourth scrolling unit associated with each of the subordinate subcylinders.

21. The method of claim 18, further comprising:
sorting all data stored in the cylindrical object based on the key subcylinder.

22. The method of claim 18, further comprising:
selectively rearranging the cylindrical object in response to a user's designation of one of the subordinate subcylinders as a new key subcylinder.

23. The method of claim 18, wherein the key subcylinder is visually distinguishable from all other subcylinders in the cylindrical object.

24. The method of claim 18, further comprising:
determining whether the user intends to create a new data set or modify an existing data set when one of the values in the currently displayed related data set corresponding to one of the subordinate subcylinders is changed; and
creating the new data set based this determination.

25. The method of claim 12, wherein the plurality of related data sets are ad-hoc data entered by a user when filling web forms.

26. A method of providing a graphical user interface (GUI) for managing data sets, the method comprising the steps of:
storing a plurality of related data sets; and
displaying one of the plurality of related data sets at a time using the GUI, wherein the GUI includes a cylindrical object for displaying the related data sets.

27. The method of claim 26, wherein, in the displaying step, the cylindrical object is a computer-generated graphical image having a cylindrical configuration.

28. The method of claim 27, wherein the cylindrical object is rotatable to display a different one of the related data sets.

29 The method of claim 27, wherein the related data sets include personal information of the user.

30. The method of claim 27, wherein the plurality of related data sets are ad-hoc data entered by a user when filling web forms.

31. The method of claim 27, wherein, in the displaying step, the cylindrical object includes a key subcylinder, assigned to a key data field, for storing a plurality of values corresponding to the key data field; a plurality of subordinate subcylinders assigned respectively to a plurality of subordinate data fields, each of the subordinate subcylinders storing a plurality of values corresponding to the assigned subordinate data field; and a viewing facet for displaying one of the related data sets, the one of the related data sets including values corresponding to the key data field and the subordinate data fields.

32. A computer program product embodied on computer readable media readable by a computing device, for managing data sets using a cylindrical object functioning as a graphical user interface, the product comprising computer executable instructions for:
obtaining a plurality of related data sets corresponding to a plurality of data fields;
identifying one of the data fields as a key field;
organizing the plurality of related data sets based on the key field; and
displaying one of the related data sets at a time using the cylindrical object.

33. The computer program product of claim 32, wherein the one of the related data sets is displayed in the cylindrical object in response to a user's request.

34. The computer program product of claim 32, further comprising computer executable instructions for:
determining whether any data field needs to be filled currently by the user; and
displaying one of the related data set based on certain criteria when the determining step indicates that the data field needs to be filled.

35. The computer program product of claim 32, further comprising computer executable instructions for:
receiving a user's selection of one of the related data sets that is displayed by the cylindrical object; and
automatically filling current data fields with the selected related data set.

36. The computer program product of claim 32, further comprising computer executable instructions for:
rotating the cylindrical object in response to a user's request to display a different one of the related data sets.

37. The computer program product of claim 32, wherein the plurality of related data sets are ad-hoc data entered by the user when filling web forms.

38. The computer program product of claim 32, wherein the cylindrical object includes a key subcylinder, assigned to a key data field, for storing a plurality of values corresponding to the key data field; a plurality of subordinate subcylinders assigned respectively to a plurality of subordinate data fields, each of the subordinate subcylinders storing a plurality of values corresponding to the assigned subordinate data field; and a viewing facet for displaying one of the related data sets, the displayed one of the related data sets including values corresponding to the key data field and the subordinate data fields.

39. The computer program product of claim 38, further comprising computer executable instructions for:
rotating simultaneously, using a first scrolling unit associated with the key subcylinder, the key and subordinate subcylinders to a predetermined amount in a first direction to display a different one of the related data sets; and
rotating simultaneously, using a second scrolling unit associated with the key subcylinder, the key and subordinate subcylinders to the predetermined amount in a second direction to display a different one of the related data sets.

40. The computer program product of claim 38, further comprising computer executable instructions for:
rotating the subordinate subcylinders individually in a first direction using a third scrolling unit associated with each of the subordinate subcylinders; and
rotating the subordinate subcylinders individually in a second direction using a fourth scrolling unit associated with each of the subordinate subcylinders.

41. The computer program product of claim 38, further comprising computer executable instructions for:
sorting all data stored in the cylindrical object based on the key subcylinder.

42. The computer program product of claim 38, further comprising computer executable instructions for:
selectively rearranging the cylindrical object in response to a user's designation of one of the subordinate subcylinders as a new key subcylinder.

43. The computer program product of claim 38, wherein the key subcylinder is visually distinguishable from all other subcylinders in the cylindrical object.

44. The computer program product of claim 38, further comprising computer executable instructions for:
determining whether the user intends to create a new data set or modify an existing data set when one of the values in the currently displayed data set corresponding to one of the subordinate subcylinders is changed; and
creating the new data set based this determination.

45. A computer program product embodied on computer readable media readable by a computer device, for providing a graphical user interface (GUI) for managing data sets, the computer program product comprising computer executable instructions for:
storing a plurality of related data sets; and
displaying one of the plurality of related data sets at a time using the GUI, wherein the GUI includes a cylindrical object for displaying the related data sets.

46. The computer program product of claim 45, further comprising computer executable instructions for:
generating the cylindrical object, wherein the cylindrical object is a computer-generated graphical image having a cylindrical configuration.

47. The computer program product of claim 46, further comprising computer executable instructions for:
rotating the cylindrical object to display a different one of the related data sets in response to a user's request.

48. The computer program product of claim 45, wherein the cylindrical object includes a key subcylinder, assigned to a key data field, for storing a plurality of values corresponding to the key data field; a plurality of subordinate subcylinders assigned respectively to a plurality of subordinate data fields, each of the subordinate subcylinders storing a plurality of values corresponding to the assigned subordinate data field; and a viewing facet for displaying one of the related data sets, the one of the related data sets including values corresponding to the key data field and the subordinate data fields.

49. The computer program product of claim 45, wherein the plurality of related data sets are ad-hoc data entered by the user when filling web forms.
